(19) United States
(12) Patent Application Publication
(10) Pub. No.: US 2023/0229139 A1
(43) Pub. Date: Jul. 20, 2023

(54) AUTONOMOUS VEHICLE/ROBOT CONTROL

(71) Applicant: Stealth Technologies Pty Ltd, Subiaco (AU)

(72) Inventors: Elliot NICHOLLS, Subiaco (AU); Chao ZHANG, Subiaco (AU); Travis POVEY, Subiaco (AU); Stuart SPIEDEL, Subiaco (AU); Craig BROGLE, Subiaco (AU); Thomas BRÁUNL, Subiaco (AU)

(73) Assignee: Stealth Technologies Pty Ltd, Subiaco (AU)

(21) Appl. No.: 17/916,111

(22) PCT Filed: Mar. 31, 2021
(86) PCT No.: PCT/AU2021/050297

§ 371 Date: Sep. 30, 2022

(30) Foreign Application Priority Data
Mar. 31, 2020 (AU) 2020900996

(51) Int. Cl. G05B 19/414; G05B 19/4067; G05B 19/042; G05D 1/00

(52) U.S. Cl. CPC G05B 19/414; G05B 19/4067; G05B 19/0428; G05D 1/0077; G05D 1/0088; G05B 2219/35546; G05B 2219/36243

(57) ABSTRACT

A control system for an autonomous vehicle or robot comprises a plurality of high level controllers. Each high level controller is able to provide high level movement commands independently of the other high level controllers. A low level controller is arranged to receive the high level movement commands of one of the high level controllers and to convert said received high level movement commands into electrical outputs to a plurality of electrical motors/actuators for driving the vehicle/robot. A decision system, independent of the high level controllers, is configured to decide which one of the high level controllers is to be active. The active high level controller only is used provide the high level movement commands to the low level controller.

### FIELD OF THE INVENTION

The present invention relates to methods and systems for controlling an autonomous vehicle or robot.

### BACKGROUND

Autonomous vehicles and robots typically have a control computer that makes high level decisions about what actions the vehicle should take in performing a mission. For example, drive forward, turn left and stop. These decisions are acted upon by lower level controllers and electronics which enact the higher level command. For example, rotate drive wheels of the vehicle at 5 m/s or turn steering wheels of the vehicle to −20°, or stop rotation of the drive wheels.

In some circumstances it is desirable to have a backup of the one or more of the systems so that if there is a failure, the vehicle does not end up in a dangerous situation.

U.S. Pat. No. 7,576,286 describes high level microcontrollers with a takeover action of one microcontroller handled within a second one of the microcontrollers.

US 20030144778 describes an engine controller with one CPU.

U.S. Pat. No. 9,207,661 describes a controller with two cores of the one control unit, but with no redundancy against hardware failure. A switchover action is led by a second one of the cores.

DE102005037246 describes two controllers in lockstep which provides for error detection if one gets out of step with the other.

EP 0322141 describes two computers which are active and dependent on each other such that if one fails the system fails.

US 20210034479 describes two devices that can provide high level movement commands but these devices perform other functions and may be susceptible to failure of the other function which can cause failure of the movement control.

US 20010035149 describes movement control being split into strategic level movement commands issued by one controller and tactical level movement commands issued by another controller based on the strategic commands, with a vehicle management controller receiving the tactical commands.

CN 108196547 describes an alternative decision making unit monitors the status of a main decision making unit.

These prior art controllers suffer from various deficiencies.

An aspect of the present invention seeks to provide for a redundancy in the high level controller.

Any document, reference, patent application or patent that might be cited in this text is expressly incorporated herein in their entirety by reference, which means that it should be read and considered by the reader as part of this text. That the document, reference, patent application, or patent cited in this text is not repeated herein is merely for reasons of conciseness.

In this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive.

### SUMMARY OF THE INVENTION

According to a first aspect of the present invention there is provided a control system for an autonomous vehicle or robot comprising:

a plurality of high level controllers, wherein each high level controller is able to provide high level movement commands independently of the other high level controllers;

a low level controller arranged to receive the high level movement commands of one of the high level controllers and to convert said received high level movement commands into electrical outputs to a plurality of electrical motors/actuators for driving the vehicle/robot;

a decision system, independent of the high level controllers, which is configured to decide which one of the high level controllers is to be active, wherein the active high level controller only is used provide the high level movement commands to the low level controller.

In an embodiment, the control system further comprises a messaging system for transferring the high level movement commands of the active high level controller to the low level controller. In an embodiment, the messaging system is also for transferring low level responses of the low level controller to the active high level controller.

In an alternative embodiment the decision system comprises a heartbeat signal detector for checking for receipt of a heartbeat signal sent from the active high level controller. In an embodiment, the decision system checks for receipt by the low level controller of a heartbeat signal sent from the active high level controller. In an embodiment the decision system is configured such that when said heartbeat signal is not received by the low level controller, which high level controller is the active high level controller is changed.

In an embodiment, the messaging system indicates to the high level controllers which one of the high level controllers is the active high level controller.

In an embodiment, the decision system comprises a network messaging controller configured to record which high level controller is the active high level controller. In an embodiment, the messaging system comprises the network messaging controller.

In an embodiment, the heartbeat signal detector is configured to signal to the network messaging controller that the active high level controller is to be changed when said heartbeat signal is not received by the low level controller.

In an embodiment, the active high level controller is configured to calculate the vehicle/robot trajectory and produce the high level movement commands from the calculated trajectory.

In an embodiment, the or each high level controller that is not the active high level controller idles until it become the active high level controller. In an embodiment, idling comprises synchronising state to that of the active high level controller.

In an embodiment, the control system further comprises a network switch for sharing data, including the aforementioned signals, between connected elements of the network, including the controllers and decision system.

In an embodiment, the control system further comprises a plurality of sensors, wherein the sensors are connected to the network and provide sensed data to one or more of the connected elements of the network.

In an embodiment, the active high level controller consumes the sensed data from the sensors. In an embodiment, the active high level controller computes the high level movement commands using the sensed data.

In an embodiment, the active high level controller transmits the high level movement command only to the low level controller over the network.

In an embodiment, the decision system sets an initial active controller according to a default upon first boot of the control system.

In an embodiment, upon change of a high level controller the high level controller that was the active controller is re-booted/reset. In an embodiment, when a high level controller is to be re-booted/reset, the decision system sends a power cycle signal to the high level controller that is to be re-booted/reset.

In an embodiment, the low level controller provides feedback from sensors associated with the motors/actuators to the active high level controller. In an embodiment, the low level controller provides acknowledgement responses to commands from the active high level controller. In an embodiment, the feedback is provided with the responses.

In an embodiment, the high level movement commands are conveyed from the active high level controller to the low level controller via the heartbeat signal.

According to another aspect of the present invention there is provided a method of controlling an autonomous vehicle or robot comprising:

providing a plurality of high level controllers;

providing a low level controller;

providing a decision system, making one of the high level controllers active;

the active high level controller providing high level movement commands independently of the other high level controllers to the low level controller;

the low level controller receiving the high level movement commands of the active high level controller and converting said received high level movement commands into electrical outputs to a plurality of electrical motors/actuators for driving the vehicle/robot;

the decision system deciding, independently of the high level controllers, to change the active high level controller.

In an embodiment, the method comprises idling the or each other high level controller that is not made active. In an embodiment the or each idling high level controller synchronise its/their states with the active high level controller.

In an embodiment, the method comprises transferring the high level movement commands of the active high level controller to the low level controller. In an embodiment, the includes transferring low level responses of the low level controller to the active high level controller.

In an embodiment, the method includes checking for receipt by the low level controller of a heartbeat signal sent from the active high level controller, wherein when said heartbeat signal is not received by the low level controller, which high level controller is the active high level controller is changed.

In an embodiment, the method includes indicating to the high level controllers which one of the high level controllers is the active high level controller.

In an embodiment, the method includes recording which high level controller is the active high level controller.

According to another aspect of the present invention there is provided a control system for an autonomous vehicle or robot comprising:

a plurality of high level controllers, wherein each high level controller is able to provide high level movement commands to a low level controller; the low level controller arranged to receive the high level movement commands of one of the high level controllers and to convert said received high level movement commands into electrical outputs to a plurality of electrical motors/actuators for driving the vehicle/robot;

a plurality of sensors for receiving data about the vehicle/robot and/or its environment;

a network connecting elements comprising the high level controllers, the low level controller and the sensors;

wherein the elements are independently addressable so as to have separate responsibility for being a source and/or a destination of data conveyed by the network.

In an embodiment, the control system further comprises a decision system, independent of the high level controllers, and which is configured to decide which one of the high level controllers is to be active, wherein the active high level controller only is used provide the high level movement commands to the low level controller.

In an embodiment, the control system further comprises a messaging system for transferring the high level movement commands of the active high level controller to the low level controller.

In an embodiment, the control system comprises a network messaging controller configured to coordinate messaging over the network.

In an embodiment, the network comprises a network switch for routing data according to the coordination provided by the network messaging controller.

In an embodiment, the network messaging controller is a publish and subscribe messaging system. In an embodiment, the network messaging controller is a ROS server.

In an embodiment, the sensors are each connected to the network by a ROS Adaptor.

In an embodiment, the low level controller is connected to the network by a ROS Adaptor.

In an embodiment, each high level controller is connected to the network by a separate network interface adaptor.

According to another aspect of the present invention there is provided a method of controlling an autonomous vehicle or robot comprising:

providing a plurality of high level controllers each able to produce high level movement commands, a low level controller arranged to receive the high level movement commands of one of the high level controllers and to convert said received high level movement commands into electrical outputs to a plurality of electrical motors/actuators for driving the vehicle/robot, a plurality of sensors for receiving data about the vehicle/robot and/or its environment, and a network connecting network elements comprising said high level controllers, the low level controller and the sensors;

the network conveying messages between the network elements such that they are independently addressable so that each has a separate responsibility for being a source and/or a destination of the messages conveyed by the network.

Various aspects or embodiments described herein can be practiced alone or combination with one or more of the other aspects/embodiments, as will be readily appreciated by those skilled in the relevant art. The various aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the aspects, certain advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### DESCRIPTION OF FIGURES

In order to provide a better understanding of the present invention preferred embodiments will now be described with reference to the accompanying drawings, in which:

FIG. 1 is a schematic block diagram of a control system for a drive by wire autonomous vehicle according to an embodiment of the present invention;

FIG. 2 is a flow chart showing a method of high level control of a drive by wire autonomous vehicle according to an embodiment of the present invention; and

FIG. 3 is a flow chart of a method of low level control of a drive by wire autonomous vehicle according to an embodiment of the present invention.

In the figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the arrangements of the embodiment(s) as well as of the particular applications of such embodiment(s).

Specifically, reference to positional descriptions, such as ‘lower’ and ‘upper’, and associated forms such as ‘uppermost’ and ‘lowermost’, are to be taken in context of the embodiments shown in the figures, and are not to be taken as limiting the scope of the principles described herein to the literal interpretation of the term, but rather as would be understood by the skilled reader.

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION OF EXAMPLE EMBODIMENTS

The words used in the specification are words of description rather than limitation, and it is to be understood that various changes may be made without departing from the spirit and scope of any aspect of the invention. Those skilled in the art will readily appreciate that a wide variety of modifications, alterations, and combinations can be made with respect to the above described embodiments without departing from the spirit and scope of any aspect of the invention, and that such modifications, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

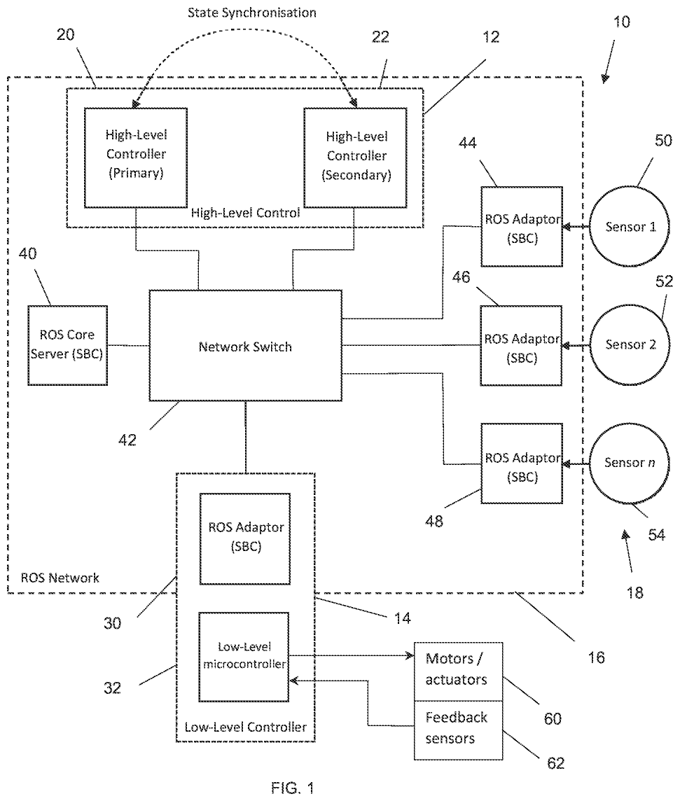

Referring to FIG. 1, there is shown a control system 10 for a drive by wire autonomous vehicle according to an embodiment of the present invention which comprises a high level control system 12, a low level control system 14, a communication system 16 and sensors 18. The autonomous vehicle may include but is not limited to being wheeled, tracked, half tracked, flying (wing or downward thrust rotor based (eg. ‘drone’), or water based (ship, boat or submersible) or rocket propelled. This control system 10 can also be used for mobile autonomous robots.

The high level control system 12 comprises a plurality of high level controllers 20, 22. In this example there are two, but it will be understood that three or more can be used. Each high level controller 20 or 22 is able to provide high level movement commands independently of the other high level controllers. Each high level controller is preferably a general purpose computer configured with software to operate specifically as the high level controller with configuration and functionality described below. The software may comprise an autonomous vehicle computing platform for controlling the operation of the vehicle so as to perform a mission. For example, the autonomous vehicle computing platform may be the Nvidia Drive platform. The software comprises instructions, which when executed by a processor of the high level controller, configure it to operate as described. The instructions may be implemented in any suitable language and operate within any suitable environment (operating system), wherein the specific form of the instructions will be determined by the skilled person in order to control the high level processor according to the description herein. An aspect of the invention relates to what the high level processor must do to operate according to the description herein. Because each high level controller is not necessarily hardened and/or because mission control software is complex and/or for other reasons, it may be prone to a failure. Each high level controller 20, 22 may be assigned an identification (ID).

Preferably the high level controllers 20, 22 (or high level processors) are physically discrete devices such that if one fails it typically will not cause the other(s) to fail. Preferably, the high level controllers 20, 22 are physically located on the robot/vehicle so as to not be susceptible to communication failure, such as for example in a radio harsh or mandated radio quiet environment.

The low level control system 14 comprises a low level controller 32 arranged to receive the high level movement commands of one of the high level controllers 20, 22 and to convert said received high level movement commands into electrical outputs to a plurality of electrical motors/actuators 60 for driving the vehicle. The motor may be a drive motor for moving the vehicle forward or backwards. The actuator may be a steering actuator for angling the steering wheels to the required angle to turn the vehicle. Other actuator forms are possible, such as track drive, brakes, or caster wheel drive etc.

The low level controller 32 may be a general purpose computer configured with software to operate specifically as the low level controller with configuration and functionality described below. The software comprises instructions, which when executed by a processor of the low level controller 32 configure it to operate as described. The instructions may be implemented in any suitable language and operate within any suitable environment, wherein the specific form of the instructions will be determined by the skilled person in order to control the low level processor according to the description herein. An aspect of the invention relates to what the low level processor must do to operate according to the description herein.

Alternatively, the low level controller may be formed of custom electronics devices, such as a programmable logic controller (PLC) and associated electronics circuits. The PLC may be programmed to operate with similar (but usually lower level) instructions for control of the PLC to operate as described.

The communication system 16 is in the form of a messaging system for transferring the high level movement commands of the active high level controller 20 or 22 to the low level control system 14. The communication system 16 may comprise an Ethernet network, or wireless network (for example Bluetooth or WiFi). The communication system 16 also provides sensor data from sensors 18 which sense the environment of, or characteristics of, the vehicle. For example, the sensors 18 may comprise one or more of a RADAR, LIDAR, a GPS system, an accelerometer or IMU, a gyroscope, distance (eg ultrasonic) sensors, or a video feed. The communication system 16 comprises a computer network, which preferably includes a communication switch 42. For example, the switch 42 may comprise an Ethernet switch.

In an embodiment, the active high level controller 20 or 22 is configured to receive signals from the sensors 18 via the communication system 16. In particular the active high level controller 20 or 22 consumes the sensor data from the sensors 18. In an embodiment, the active high level controller 20 or 22 is configured to calculate the vehicle trajectory based on the received signals and based on a mission, and is also configured to produce the high level movement commands from the calculated trajectory. In an embodiment, the active high level controller 20 or 22 transmits the high level movement commands only to the low level control system 14 over the network 16. Typically, the communication from the high level controllers 20, 22 to the low level control system 14 is wired so as to not be susceptible to interference or a breakdown of wireless communication.

The control system 10 further comprises a decision system, independent of the high level controllers 20, 22, and which is configured to decide which one of the high level controllers 20 or 22 is to be active. In an embodiment, the active high level controller 20 or 22 only is used provide the high level movement commands to the low level control system 14.

In an embodiment, the decision system comprises an element of the low level control system 14. In an embodiment, the element is the low level controller 32. In an embodiment, the decision system comprises an element of the communication system 16. In an embodiment the element (of the communication system 16) is a server device 40.

In an embodiment, the decision system comprises a heartbeat signal detector for checking for receipt of a heartbeat signal sent from the active high level controller 20 or 22 by the low level controller 32. The decision system is configured such that when said heartbeat signal is not received by the low level controller 32 the active high level controller 20 or 22 is changed. In an embodiment, the low level controller 32 is configured to operate as the heartbeat signal detector. In an embodiment, the active high level controller 20 or 22 is configured to act as a heartbeat signal generator and is configured to transmit the heartbeat signal across the communication network 16 to the low level controller 32.

In an embodiment, the server device 40 of the messaging system is configured to indicate to the high level controllers 20, 22 which one of the high level controllers is the active high level controller 20 or 22.

In an embodiment, the server 40 is a network messaging controller configured to record which high level controller 20, 22 is the active high level controller.

In an embodiment, the heartbeat signal detector (functionality of the low level controller 32) is configured to signal to the network messaging controller (of the server 40), via the communication network 16 that the active high level controller 20 or 22 is to be changed when said heartbeat signal is not received by the heartbeat signal detector (of the functionality of the low level controller 32).

In an embodiment, the or each high level controller 20, 22, that is not the active high level controller 22 or 20, is configured to idle until it becomes the active high level controller. In an embodiment, idling comprises synchronising state to that of the active high level controller 20 or 22. The state synchronisation is sufficient for the high level controller 22 or 20 to take over as the active controller as seamlessly as possible. Typically, the idling comprises receiving the sensor input received by the active high level controller. It may further comprises processing the input as if it was the active high level controller but does not produce the output to the low level controller. Thus, typically the inactive high level controller is not suspended. Resuming a suspended machine may cause too long a delay in hand over from the currently active high level controller to the inactive one.

In an embodiment, the decision system is configured to set an initial active controller according to a default upon first boot of the control system 10. In an embodiment, the default is recorded in the server 40.

In an embodiment, upon change of a high level controller 22 or 20, the high level controller 20 or 22 that was the active controller is re-booted/reset. In an embodiment, when a high level controller is to be re-booted/reset the decision system is configured to send a power cycle signal to the high level controller 20 or 22 that is to be re-booted/reset. Failure of the active high level controller can sometimes be rectified by the reboot/reset, particularly if the failure is a system hang.

In an embodiment, the motors/actuators 60 have associated sensors 62 arranged to provide feedback to the low level controller 32. In an embodiment, the feedback ensures that the motors/actuators 60 are performing as intended to be controlled. For example, a drive wheel needs to rotate at 20 rpm to produce a particular speed, the respective sensor will measure the rotational output of the motor driving the drive wheel. In an embodiment, the low level controller 32 is configured to provide the feedback from sensors 62 associated with the motors/actuators to the active high level controller 20 or 22. In an embodiment, the low level controller 32 is configured to provide acknowledgement responses to the active high level controller's commands. In an embodiment, the feedback from the sensors 62 is provided with the responses to the high level commands.

In an embodiment, the high level movement commands are conveyed from the active high level controller 20 or 22 to the low level controller 32 via the heartbeat signal.

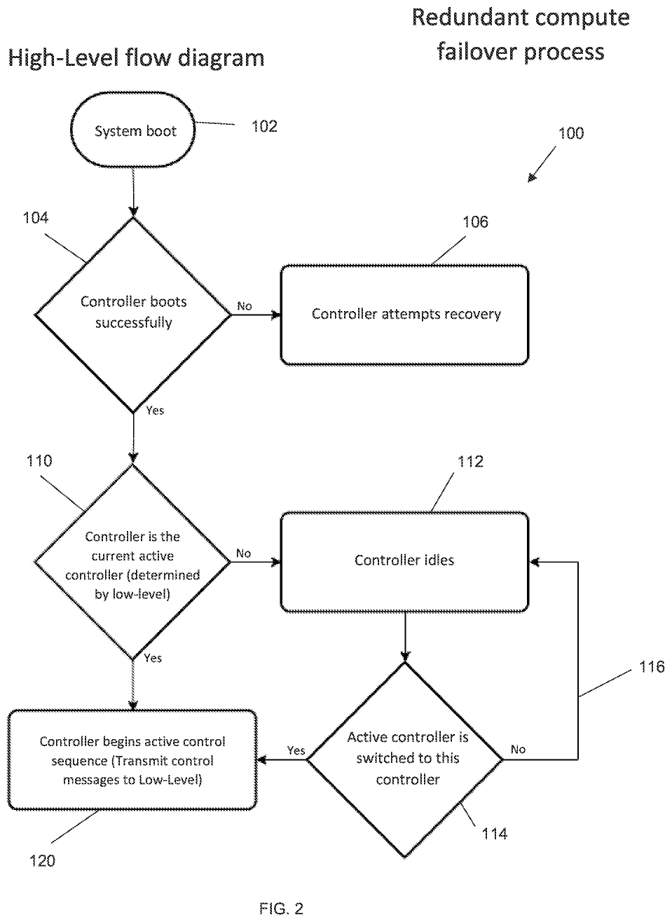

Referring to FIG. 2, there is an embodiment of a method 100 of control of a high level controller 20, 22. In the method 100 the high level controllers are booted 102. They will load a BIOS, then an operating system, then the software application mentioned above. In the boot process they will acquire a local network address (which may be fixed for the device or allocated, such as by a DHCP server operating as part of the server 40). The server 40 receives a message from each high level controller 20, 22 indicating that it has successfully booted and the software application is running. The server 40 checks for this successful boot at 104. In the event that one or both of the high level controllers has not successfully booted the respective high level controller may be power cycled (typically by command of the server 40 sent to its network adaptor), or some other recovery may be initiated at 106.

If the high level controllers 20, 22 have successfully booted, one of the high level controllers is allocated as the active high level controller. Typically, the low level controller 32 makes the determination of which high level controller 20, 22 will be the active controller and informs the server 40, although there may be a default selection. The server 40 then informs the high level controllers 20,22 which one is the active one.

Each high level controller checks the received identification of the active controller against its own identification. If the respective high level controller is not the active controller it enters the idle mode at 112, where it synchronises its data with that of the active high level controller so that if it is switch to being the active controller it can promptly take over this role.

At 114, each high level controller 20, 22 reassesses whether it have been informed it should take over as the active controller, and if not continues in idle mode, at 116. If it is informed to take over as active high level controller or if it is originally allocated to be the high level controller then it begins (or takes over) performing the mission. It does this by receiving/consuming sensor data, and based on this, issues high level commands to the low level control system 14 in form of messages containing the heartbeat signal and control commands. These messages are addressed to the low level control system 14 and send via the communication system 16.

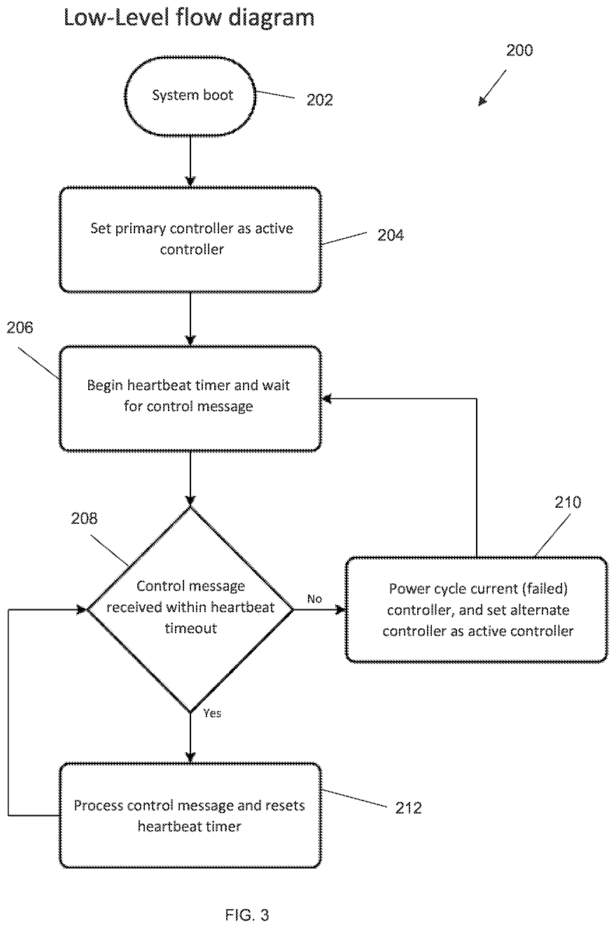

Referring to FIG. 3, there is an embodiment of a method 200 of control of a low level control system 14. In the method 200 the low level controller is booted 202. The low level controller decides which high level controller 20, 22 will be the active controller. There may be a default selection of which high level controller is allocated as the active one (that is, there is a pre-set primary controller), or it may be chosen by other means (for example alternating if there are two, or round robin if there are more than two, or by random allocation). The low level control system 14 informs the server 40 which controller 20, 22 is the active high level controller at 204. Alternative means of informing the high level controller are also possible, such as the low level controller directly informing the high level controllers.

At 206, the low level control system 14 commences listening for messages. As noted above, the messages listened for are the heartbeat signal and high level vehicle control commands. A timer is counted down for receipt of the heartbeat signal. Each heartbeat signal may have a timestamp to determine whether they are current. At 208, it is determined whether the heartbeat signal is received within the required time. If it is not, then at 210, it is assumed there is a problem with the active controller. In this case a command is sent to the active controller to perform a power cycle and one of the other high level controllers is then set in an internal memory/registry as the active high level controller so that it can take over control of the vehicle. This is sent to the server 40 for in turn sending to the other high level controllers 20, 22 so that they are informed which one is the new active high level controller. Following this the flow returns to step 206.

In the event that the heartbeat signal is received in time, then at 212, the control message is acted upon by outputting electrical signals to the motor/actuators 60, the heartbeat countdown timer is reset and an acknowledge message with current motor/actuator feedback is sent to the active high level controller 20 or 22. The process then flows to step 208.

In the communication network 16, each of the plurality of high level controllers 20, 22, the low level control system 14, the plurality of sensors 18 (and server 40) are independently addressable so as to have separate responsibility for being a source and/or a destination of data conveyed by the network 16.

In an embodiment, the network messaging controller is a publish and subscribe messaging system. In an embodiment the server 40 comprising the network messaging controller is a ROS server.

In an embodiment, the sensors 18 are each connected to the network by a network adaptor, such as a ROS Adaptor 44, 46 and 48. In an embodiment, the low level controller 32 is connected to the network by a network adaptor, such as a ROS Adaptor 30.

In an embodiment each high level controller is connected to the network by a separate network interface adaptor.

Example code for software to implement the High Level Controller (HLC) Process is below:

1.1 HLC Process

```
HighLevelController:
# Arbitrary value for this HLC’s ID
my_id = 1
boot:
if my_id is LowLevelController.active_id:
    execute control_task;
else:
  execute idle_task;
idle_task:
  while my_id is not LowLevelController.active_id:
    synchronise state with active controller;
  # Here the active_id has changed to be the my_id
  execute control_task;
control_task:
  while my_id is LowLevelController.active_id:
    calculate vehicle trajectory
    send control message to LowLevelController
  # Here my_id is no longer the active_id
  execute idle_task;
```

Example code for software to implement the Low Level Controller (LLC) Process is below:

1.2 LLC Process

```
  LowLevelController:
  boot:
    active_id = 1;
    # Create a timer that will count down 5 seconds, then expire (in an
alternative the time may be 300 ms)
    heartbeat_timer = timer(5 s);
    start heartbeat_timer;
    execute wait_for_message;
  wait_for_message:
    if message received:
      execute process_message;
    else if heartbeat_timer has expired:
      execute failover;
    else:
      increment timer;
  process_message:
    act on message;
    send response message;
    # Reset the timer to start counting from 0 again
    reset heartbeat_timer;
  failover:
    power cycle HighLevelController with active_id
    active_id = 2;
    reset heartbeat_timer;
    execute wait_for_message;
```

The present invention has the advantage of each component being independent and does not require any other computer to function (if the low-level is not available, the high level won't be able to issue any control commands, but it will still boot and can interact with the network).

There are two key advantageous outcomes of this design:
1. The communication channel between HLC and LLC is not a fixed line (i.e. serial), allowing for software switching between HLC devices; and
2. The sensors are not owned by any other component (each sensor sits behind a single board computer (SBC) adaptor, which serves as an interface to the network
   a. This allows either HLC to subscribe to the sensor via its network address.

The central network in this embodiment is powered by the Robot Operating System (ROS), which is a publish/subscribe communication system. Using this system, a HLC can easily subscribe to data being published by a sensor, and the LLC can subscribe to messages being published by the HLC.

1.1.1 HLC Switching Implementation

The HLC switching procedure occurs in the LLC, on the network side. The LLC is comprises two parts:
1. Microcontroller: takes a drive command (speed, steering angle), and converts it into the electrical signals that drive the actuators that control the vehicle.
2. Ros Adaptor: serves as the interface to the ROS network, it subscribes to control messages from the HLC and passes them onto the LLC via serial.

In an alternative implementation, the decision to switch high level controllers is made outside the LLC, but the actual switching is done from the LLC. In an embodiment there may be an additional heartbeat from the low level to the high level. This may not be for switching the high level controller, it may be for safety (eg if no commands are received by the active high level controller the vehicle will emergency brake).

The Ros Adaptor 30 is responsible for handling the active HLC, this gives a layer of abstraction between the low-level controller 32 and where the message is coming from. The controller 32 can therefore focus on execution of drive commands. This functional focus increases the reliability of the low level control system 14.

Modifications and variations as will be apparent to the skilled addressee are intended to fall within the scope of the present invention.

1. A control system for an autonomous vehicle or robot comprising:
a plurality of high level controllers, wherein each high level controller is able to provide high level movement commands independently of the other high level controllers;
a low level controller arranged to receive the high level movement commands of one of the high level controllers and to convert said received high level movement commands into electrical outputs to a plurality of electrical motors/actuators for driving the vehicle/robot;
a decision system, independent of the high level controllers, which is configured to decide which one of the high level controllers is to be active, wherein the active high level controller only is used provide the high level movement commands to the low level controller.

2. The control system according to claim 1, wherein the control system further comprises a messaging system for transferring the high level movement commands of the active high level controller to the low level controller.

3. The control system according to claim 2, wherein the messaging system is also for transferring low level responses of the low level controller to the active high level controller.

4. The control system according to claim 2, wherein the decision system comprises a heartbeat signal detector for checking for receipt by the low level controller of a heartbeat signal sent from the active high level controller, wherein the decision system is configured such that when said heartbeat signal is not received by the low level controller, which high level controller is the active high level controller is changed.

5. The control system according to claim 4, wherein the messaging system indicates to the high level controllers which one of the high level controllers is the active high level controller.

6. The control system according to claim 5, wherein the decision system comprises a network messaging controller configured to record which high level controller is the active high level controller.

7. (canceled)

8. The control system according to claim 6, wherein the heartbeat signal detector is configured to signal to the network messaging controller that the active high level controller is to be changed when said heartbeat signal is not received by the low level controller.

9. The control system according to claim 1, wherein the active high level controller is configured to calculate the vehicle/robot trajectory and produce the high level movement commands from the calculated trajectory.

10. The control system according to claim 1, wherein the or each high level controller that is not the active high level controller idles until it become the active high level controller.

11. The control system according to claim 10, wherein idling comprises synchronising state to that of the active high level controller.

12. The control system according to claim 1, wherein the control system further comprises a network switch for sharing data, including the aforementioned signals, between connected elements of the network, including the controllers and decision system.

13. The control system according to claim 1, wherein the control system further comprises a plurality of sensors, wherein the sensors are connected to the network and provide sensed data to one or more of the connected elements of the network.

14. The control system according to claim 13, wherein the active high level controller consumes the sensed data from the sensors.

15. The control system according to claim 14, wherein the active high level controller computes the high level movement commands using the sensed data.

16. The control system according to claim 1, wherein the active high level controller transmits the high level movement command only to the low level controller over the network.

17. The control system according to claim 1, wherein the decision system sets an initial active controller according to a default upon first boot of the control system.

18. (canceled)

19. (canceled)

20. The control system according to claim 1, wherein the low level controller provides feedback from sensors associated with the motors/actuators to the active high level controller.

21. The control system according to claim 1, wherein the low level controller provides acknowledgement responses to commands from the active high level controller.

22. The control system according to claim 4, wherein the high level movement commands are conveyed from the active high level controller to the low level controller via the heartbeat signal.

23. A method of controlling an autonomous vehicle or robot comprising:
providing a plurality of high level controllers;
providing a low level controller;
providing a decision system,
making one of the high level controllers active;
the active high level controller providing high level movement commands independently of the other high level controllers to the low level controller;
the low level controller receiving the high level movement commands of the active high level controller and converting said received high level movement commands into electrical outputs to a plurality of electrical motors/actuators for driving the vehicle/robot;
the decision system deciding, independently of the high level controllers, to change the active high level controllers.

24. (canceled)

25. (canceled)

26. (canceled)

27. (canceled)

28. (canceled)

29. (canceled)

30. (canceled)

31. A control system for an autonomous vehicle or robot comprising:
a plurality of high level controllers, wherein each high level controller is able to provide high level movement commands to a low level controller; the low level controller arranged to receive the high level movement commands of one of the high level controllers and to convert said received high level movement commands into electrical outputs to a plurality of electrical motors/actuators for driving the vehicle/robot;
a plurality of sensors for receiving data about the vehicle/robot and/or its environment;
a network connecting elements comprising the high level controllers, the low level controller and the sensors;
wherein the elements are independently addressable so as to have separate responsibility for being a source and/or a destination of data conveyed by the network.

32. (canceled)

33. (canceled)

34. (canceled)

35. (canceled)

36. (canceled)

37. (canceled)

38. (canceled)

39. (canceled)

40. (canceled)

41. A method of controlling an autonomous vehicle or robot comprising:
providing a plurality of high level controllers each able to produce high level movement commands, a low level controller arranged to receive the high level movement commands of one of the high level controllers and to convert said received high level movement commands into electrical outputs to a plurality of electrical motors/actuators for driving the vehicle/robot, a plurality of sensors for receiving data about the vehicle/robot and/or its environment, and a network connecting network elements comprising said high level controllers, the low level controller and the sensors;
the network conveying messages between the network elements such that they are independently addressable so that each has a separate responsibility for being a source and/or a destination of the messages conveyed by the network.
